(19) United States
(12) Patent Application Publication
(10) Pub. No.: US 2019/0041336 A1
(43) Pub. Date: Feb. 7, 2019

(54) ISOTOPIC MEASURING DEVICE

(71) Applicant: COMMISSARIAT A L'ENERGIE ATOMIQUE ET AUX ENERGIES ALTERNATIVES, Paris (FR)

(72) Inventor: Jean-Baptiste SIRVEN, Paris (FR)

(21) Appl. No.: 16/054,659

(22) Filed: Aug. 3, 2018

(30) Foreign Application Priority Data
Aug. 7, 2017 (FR) 1757567

(51) Int. Cl. G01N 21/75; G01N 21/31; G01N 21/33

(52) U.S. Cl. CPC G01N 21/75; G01N 21/33; G01N 21/3103

(57) ABSTRACT

A measuring method for measuring an isotope ratio of an element present in a material includes a plurality of elements, the method comprising the following steps: a step of applying at least one laser beam to the material so as to generate a plasma, the plasma being able to emit a light spectrum comprising a plurality of spectral lines emitted by the elements of the material; a measuring step able to measure the profile of at least one spectral line of interest emitted by the element of interest, the measuring step comprising carrying out, with a spectrometer, at least one analysis of the light spectrum emitted by the plasma; a processing step able to note in the profile of the spectral line of interest the optimal wavelength corresponding to a point of equilibrium; and a step of determining the isotope ratio depending on the noted optimal wavelength.

### CROSS-REFERENCE TO RELATED APPLICATIONS

This application claims priority to foreign French patent application No. FR 1757567, filed on Aug. 7, 2017, the disclosure of which is incorporated by reference in its entirety.

### FIELD OF THE INVENTION

The invention relates to the field of isotopic measurement.

Isotopic measurement is in particular carried out in the nuclear field, in the environmental field, and in the fields of Earth sciences and of life sciences.

The invention particularly relates to measurement of a concentration ratio between two isotopes of a given chemical element (which we will also call an “element” below).

### BACKGROUND

Isotopic measurement consists in determining the presence and/or concentration in a sample of material of one or more isotopes of a chemical element.

Each element of the periodic table has one or more isotopes, namely different atoms of a given element. Two isotopes of a given element have the same number of protons and electrons but a different number of neutrons.

For solids, the most commonplace isotopic analysis techniques are based on mass spectrometry, which is capable of delivering a selective response to one or more given atomic masses corresponding to isotopes of given elements, the intensity of the response needing to be proportional to the abundance (concentration) of the isotopes.

Thus, the most commonplace techniques for solids are: mass spectrometry in which the sample is dissolved (ICP-MS, TIMS), laser ablated (LA-ICP-MS) or coupled with a glow discharge (GD-MS). Mention may also be made of the SIMS technique, which is based on the bombardment of the sample with an ion beam, and the RIMS technique, which consists in vaporising the sample in an oven before ionising the vapour produced with a laser.

Apart from the sample preparation required for the two first techniques, which may be time-consuming, the common point of all these techniques is that they are laboratory techniques, requiring bulky equipment that is difficult to miniaturise and difficult to implement outside of the laboratory, for example on an industrial scale. They are however capable of delivering very precise results.

Optical techniques exist but they apply exclusively to gases and are mainly used to measure molecules composed of light elements (H₂O, CO₂, CH₄, etc.). They are mainly based on tunable diode laser absorption spectroscopy (TDLAS) or possibly cavity ring-down spectroscopy (CRDS).

The technique inductively coupled plasma optical emission spectrometry (ICP-OES) is also known. High-resolution ICP-OES is hardly used for isotopic analysis because it is less effective than ICP-MS.

Laser-induced breakdown spectroscopy (LIBS) may also be used for isotopic analysis, in particular of solids.

LIBS is in particular described in the French publication called Techniques de l'Ingénieur p. 2870 “LIBS: spectrométrie d'émission optique de plasma induit par laser”, [LIBS: optical emission spectrometry of laser-induced plasma] Daniel L'HERMITE and Jean-Baptiste SIRVEN, published Oct. 6, 2015.

Its principle is to focus a laser pulse onto the surface of a sample of material (or of the material) in order to generate a transient plasma the light emission of which is analysed by means of a spectrometer. By collecting the light emission of the plasma and by analysing the spectrum by spectrometry, it is possible to identify the elements present in the plasma, and therefore to determine the composition of the material, on the basis of databases of emission lines.

In the example device in FIG. 1A, a laser generator 2 generates a laser beam 3 that is focused onto the sample 1 by a first optical system 4. This generates a plasma 5. The plasma 5 emits a light emission 6a that is focused by a second optical system 7. The focused light emission 6b is sent to a spectrometer 9 via an optical fibre 8. The spectrometer 9 comprises (or is associated with) a detector 9a that is synchronised with the laser generator 2. The spectrometer 9 allows line spectra to be recorded. Lastly, processing means 10 allow the recorded spectra to be processed.

The first and/or second optical system may be a lens.

As shown in FIG. 1B, LIBS allows a spectrum 20, which takes the form of a set of spectral lines 21a, 21b, 21c, 21d, 21e, 21f, to be generated. The spectral lines correspond to the emission lines of the component elements of the material and allow—using available data on the correlations between emission lines and elements—the elementary composition of the material sample to be determined. The wavelength λ of a line provides information on an element present in the material and its intensity I is related to the concentration of this element.

LIBS emission spectrometry may also be applied to isotopic analysis because the atomic lines of various isotopes of a given element are at slightly different wavelengths. This spectral shift is due to mass effects (predominant in light elements) and to modification of the charge distribution within the nucleus (predominant in heavy elements). However, this shift is generally of the order of a fraction of a nm or even of a few pm, as Table 1 below shows:

TABLE 1

| Isotopes | Emission line | Isotopic shift |
|---|---|---|
| 7Li → 6Li | 670.775 nm | +17 pm |
| 10B → 11B | 208.891 nm | −2.5 pm |
| 238U → 235U | 424.437 nm | +25 pm |
| 239Pu → 240Pu | 594.522 nm | +13 pm |

Such a shift is difficult to observe in a plasma generated by LIBS under normal conditions, because the confinement of the plasma by ambient air at atmospheric pressure leads to a high density, and therefore to a broadening of the emission lines due to the Stark effect. This broadening is commonly as much as several tens or even hundred pm and therefore masks the isotopic shift, even if the spectrometer used has a sufficiently high spectral resolution to resolve this shift. The limitation is here physical and not instrumental.

To overcome these drawbacks, several solutions are known.

A first solution consists in carrying out the analysis at low pressure, or even under vacuum. By thus limiting the confinement of the plasma by the ambient medium, its density is decreased and it is possible to achieve a sufficient spectral selectivity for certain isotopes, as may be seen in FIGS. 2A and 2B.

This approach has been employed for isotopic analysis of uranium (W. Pietsch et al., Isotope ratio determination of uranium by optical emission spectroscopy on a laser-produced plasma—basic investigations and analytical results. Spectrochim. Acta Part B 53 (1998) 751-761) and of plutonium (C. A. Smith et al., Pu-239/Pu-240 isotope ratios determined using high resolution emission spectroscopy in a laser-induced plasma. Spectrochimica Acta Part B 57 (2002) 929-937).

It is not applicable to all isotopes and requires a spectrometer of high resolving power, which is therefore bulky: spectrometer of 2 metre focal length and resolving power of about 89000 (Smith) or spectrometer of 1 metre focal length and resolving power of about 91000 (Pietsch).

A second solution consists in sending a second laser beam through the plasma, in order to measure a fluorescence signal or resonant absorption signal.

This approach has been tested for isotopic analysis of lithium (B. W. Smith et al., A laser ablation-atomic fluorescence technique for isotopically selective determination of lithium in solids. Spectrochimica Acta Part B 53 (1998) 1131-1138) and of uranium (B. W. Smith et al., Measurement of uranium isotope ratios in solid samples using laser ablation and diode laser-excited atomic fluorescence spectrometry. Spectrochimica Acta Part B 54 (1999) 943-958).

It may be seen that the devices required to implement these two solutions, whether it be a question of a low-pressure chamber or of a second laser, which moreover is tunable, are unsuitable for analysis in the field and, in the case of a second laser, lead to severe constraints with respect to the robustness and alignment of the second laser beam in the plasma. These approaches are therefore more suitable for laboratory analysis and in particular for trace analysis: in particular, the use of a second laser beam allows the species to be measured to be selectively detected, and therefore the sensitivity of the measurement to be considerably increased.

A third solution consists in a chemiometric approach to the processing of the spectra, for example using the partial-least-squares (PLS) method, which may help to overcome this limitation (partial spectral interference between the lines emitted by various isotopes). It employs a single laser, at atmospheric pressure.

This approach above all has the drawback of requiring reference samples of already known isotope ratio, to calibrate the measurement.

It is furthermore generally necessary to use a spectrometer of high resolving power, and therefore one that is inter alia more expensive and more bulky.

The LAMIS (laser ablation molecular isotopic spectrometry) technique is also an alternative derived from LIBS. It exploits the fact that the isotopic shift of molecules formed by chemical reaction between the element of interest and another element (mainly oxygen when the analysis is carried out in air) is larger than the isotopic shift of the atomic lines.

The typical case is that of boron, with a shift of 2.5 pm and 730 pm for ¹⁰B/¹¹B (atomic line at 208.89 nm) and for ¹⁰BO/¹¹BO (molecular band at 255-256 nm), respectively. This technique therefore has the same characteristics and advantages as LIBS (direct and rapid measurement at atmospheric pressure) with furthermore the possibility of using a spectrometer of moderate resolution in the most favourable cases.

One of these techniques is in particular the subject of patent application WO 2012/087405, which describes the LAMIS technique, i.e. the measurement of molecular spectra rather than atomic spectra: this method comprises applying a laser beam to the sample in ambient air under ambient pressure, thus generating the gas phase of the sample, then the measurement of at least one molecular spectrum of an isotopomer molecular species in the gas phase of the sample.

On the one hand, with the LAMIS technique described in patent application WO2012/087405, it may be necessary to provide a chamber in the device dedicated to the chemical reaction and/or to the molecular isotopic measurement post-reaction.

Another LAMIS technique is described in the publication “Standoff Detection of Uranium and its Isotopes by Femtosecond Filament Laser Ablation Molecular Isotopic Spectrometry” Kyle C. Hartig, Isaac Ghebregziabher & Igor Jovanovic; Scientific Reports volume 7, Article number 43852 (2017), which describes a method and a device for detecting, at distance, uranium and its isotopes via molecular isotopic spectrometry combined with a femtosecond (fs) filament ablation laser and thus relates to the combination of femtosecond filaments and LAMIS forming a molecular emission.

On the other hand, the LAMIS technique is restricted to elements meeting the following three conditions:
they form a molecule with another element (of the ambient medium or of the sample itself);
this molecule has an isotopic shift that is sufficiently discriminating with respect to that of the atomic lines; and
the emission of this molecule is sufficiently intense and in a spectral band accessible to the instrumentation.

Lastly, to detect a molecular emission signal, it is necessary to wait a certain time after the laser shot so that the molecules are able to form. During this time, the plasma cools and its emission decreases. Thus, the sensitivity of the LAMIS technique may be limited by the need to delay the detection of the signal.

The isotope ratios measured by LAMIS in patent application WO2012/087405 are those of B, H, C, Mn and Sr.

The invention aims to overcome the aforementioned drawbacks of the prior art.

More particularly it intends to provide an isotopic measuring method, and more particularly a method for measuring an isotope ratio, allowing the constraints related to the use of a low pressure, to the use of a second laser to probe a plasma, or to the use of spectrometers of high resolving power, or even to the need to use reference samples to calibrate the measurement, to be avoided.

One of the objectives of the invention is also to broaden the scope of application of the LAMIS technique and to make it possible to analyse all the elements without having to meet the conditions listed above.

Lastly, another objective of the invention is also to make it possible to implement such a method on an industrial scale, and not solely on a laboratory scale.

### SUMMARY OF THE INVENTION

One subject of the invention allowing this aim to be achieved is a method for measuring an isotope ratio of an element of interest present in a material including a plurality of elements.

The method comprises the following steps:
a step of applying at least one laser beam to the material so as to generate a plasma, said plasma being able to emit a light spectrum comprising a plurality of spectral lines emitted by the elements of the material; and
a measuring step carried out consecutively to the applying step and able to measure the profile of at least one spectral line of interest emitted by the element of interest, said measuring step comprising carrying out, with a spectrometer, at least one analysis of the light spectrum emitted by the plasma;
a processing step carried out consecutively to the measuring step and able to establish, depending on the profile of the spectral line of interest, the optimal wavelength corresponding either to the point of stable equilibrium corresponding to the hollow between two bells when the profile has a double-bell self-absorption profile, or to the point of unstable equilibrium corresponding to the apex of the bell profile when the profile is a single bell; and
a determining step carried out consecutively to the processing step and able to determine the isotope ratio of the element of interest depending on the noted optimal wavelength, said determining step comprising either a step of comparing with a correlation function between an isotope ratio and an optimal wavelength for a given element, or a step of implementing a multivariate method.

In the case of the point of unstable equilibrium corresponding to the apex of the single-bell profile, it may be a question of an emission profile, or of what is called a “moderate” self-absorption profile, said profile also being called a “non-inverted” self-absorption profile.

Preferably, the measuring step also comprises recording the light spectrum analysed by the spectrometer.

According to the invention, a spectrum (also called a “light spectrum” in the present description) takes the form of a curve delivering the intensity I (more broadly the amplitude) of a signal as a function of wavelength λ, and comprising a plurality of spectral lines. A “spectral-line profile” may also be spoken of in the present description to designate the shape of each line. In the present description, the expressions “line” and “spectral line” are understood to mean the same thing.

According to the invention, each spectral line has a profile that is defined as a curve segment. The profile of a spectral line has:
either a bell shape having a single peak the maximum height hₘₐₓ of which corresponds to a maximum intensity Iₘₐₓ and to a so-called maximal wavelength λₘₐₓ and having a width l measured at half the height of the line (value of the intensity equal to half the maximum intensity Iₘₐₓ at the centre of the bell);
or a double-bell shape, each bell having a peak the maximum height hₘₐₓ of which corresponds to a maximum intensity Iₘₐₓ and to a so-called maximal wavelength λₘₐₓ and having a width l measured at half the height of the line (value of the intensity equal to half the maximum intensity Iₘₐₓ at the centre of the bell).

The method according to the invention allows the constraints related to the use of a low pressure or to the use of a second laser to probe the plasma to be avoided.

It may also allow the use of a spectrometer of high resolving power, or even having to use reference samples to calibrate the measurement, to be avoided

It is enough to establish the profile of the line and to measure, depending on its profile (which may be a double-bell profile with a hollow between the two bells or a bell profile, respectively) the wavelength corresponding to the point of stable equilibrium of the hollow of the self-absorption profile (absorption maximum) or to an unstable point of equilibrium of the profile of the line (emission maximum), respectively.

Furthermore, it broadens the scope of application of the LAMIS technique in so far as potentially all the elements may be analysed, without needing to meet the conditions listed above, and it potentially allows the sensitivity of the measurement to be improved. Thus, the method according to the invention allows isotope ratios of all sorts of materials to be measured.

According to one embodiment, the measuring method comprises a step of emitting a laser beam with emitting means, such as a laser generator, prior to the step of applying said laser beam to the material

According to one preferred embodiment, the emission of said laser beam is carried out in pulses.

According to one embodiment, the measuring step is able to measure the profiles of all or some of the plurality of spectral lines of the light spectrum emitted by the plasma. In other words, the measuring step is configured to not measure only the profile of a single spectral line of interest.

According to one embodiment, the measuring method comprises a preselecting step prior to the measuring step and able to preselect at least one spectral line profile corresponding to the element of interest.

According to one embodiment, the preselecting step is carried out by selecting at least one measurement spectral band corresponding to the element of interest.

According to one embodiment, the preselecting step is carried out using a database of correspondences between spectral lines and elements.

According to one embodiment, the measuring step comprises a step of centring the spectrometer on at least one preselected spectral line profile, for example in at least one preselected measurement spectral band.

According to one embodiment, the measuring method comprises a post-selecting step carried out after the measuring step and able to select a spectral line of interest corresponding to the element of interest from a plurality of measured spectral lines.

According to one embodiment, the post-selecting step is carried out using a database of correspondences between spectral lines and elements.

According to one embodiment, the post-selecting step is carried out by viewing the profiles of the measured spectral lines and selecting, for the element of interest, a profile of a spectral line of interest.

According to one embodiment, the profile of the spectral line of interest has a double-bell shape with an absorption hollow between the two bells and the processing step comprises a step of establishing the point of stable equilibrium of said profile corresponding to the lowest point of the hollow. This also corresponds to the auto-absorption maximum.

According to one embodiment, the profile of the spectral line of interest has a bell shape and the processing step comprises a step of establishing the point of unstable equilibrium of said profile corresponding to the apex of the bell. This also corresponds to the emission maximum or to the auto-absorption maximum.

According to one embodiment, a measurement delay is respected between the step of applying a laser beam and the measuring step. This measurement delay may typically be of the order of one microsecond, or of one tenth of or of about ten microseconds.

According to one embodiment, the measuring step comprises applying an exposure time of the spectrometer to each laser shot. This exposure time may typically be of the order of one microsecond, or of one tenth of or of about ten microseconds.

According to one embodiment, the processing step is carried out by analysing the profile of the spectral line of interest. The processing may be carried out so as to mathematically determine the point of unstable equilibrium or the point of stable equilibrium and to deduce therefrom the optimal wavelength corresponding to said point of equilibrium.

According to one embodiment, the measuring method comprises a step of generating a correlation function between an isotope ratio and an optimal wavelength, for a given element. In this case, the step of determining the isotope ratio preferably comprises a step of comparing the noted optimal wavelength with said correlation function.

The method according to the invention thus has the advantage of requiring the signal to be calibrated only with respect to wavelength and not with respect to intensity.

According to one embodiment, the processing step and the step of determining the isotope ratio are merged into one and comprise a step of implementing a multivariate method, for example the partial-least-squares or neural-network regression method. This allows the isotope ratio to be determined directly from the profile of at least one spectral line of interest emitted by the element of interest.

### BRIEF DESCRIPTION OF THE DRAWINGS

Other features and advantages of the invention will become apparent from the following description, which is given by way of nonlimiting illustration and with reference to the appended drawings, in which:

FIGS. 1A and 1B illustrate an example of an LIBS setup and an example of an obtained spectrum;

FIGS. 2A and 2B illustrate a line selected from a spectrum obtained from a mixture of two isotopes (in a ratio equal to 1) of an element, with a low pressure and with two different concentrations of the element in the plasma;

FIGS. 3A and 3B illustrate a line selected from a spectrum obtained from a mixture of two isotopes (in a ratio equal to 1) of an element, at atmospheric pressure and with two different concentrations of the element in the plasma;

FIGS. 4A, 4B and 4C illustrate a line selected from a spectrum obtained at atmospheric pressure, with various isotope ratios;

FIG. 5A shows various spectra obtained from lithium-carbonate samples of variable ⁷Li/⁶Li isotope ratio;

FIG. 5B shows the relationship between the optimal absorption wavelength (wavelength of the absorption hollow) and the ⁶Li concentration deduced from the spectra of FIG. 5A;

FIGS. 6A and 6B show another embodiment of the invention; and

FIG. 7 illustrates the steps of the method according to the invention.

### DETAILED DESCRIPTION

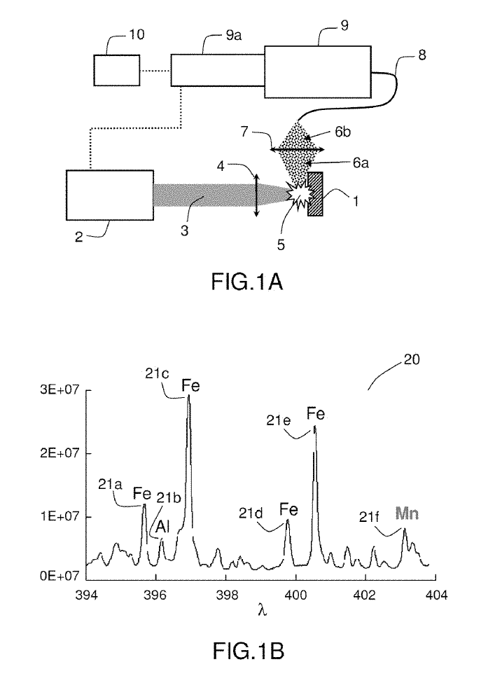

FIGS. 1A and 1B were described at the start of the present description and will not be described again here.

By way of introduction, it will be recalled that the electron transitions of atoms to higher energy levels requires energy to be provided. This energy may take the form of photons, and in this case absorption of the photons by the atom occurs. One particular case is that of a plasma. To simplify, a plasma may be considered to consist of two distinct portions, its core and its periphery. Photons emitted by the core of the plasma, which is hotter, may be absorbed by the periphery, which is colder.

This effect therefore prevents a certain number of emitted photons from exiting the plasma: this is the self-absorption effect.

For an observer outside the plasma, and for a measuring apparatus, the profile of the lines results from emission and self-absorption at the same wavelength corresponding to the electron transitions between two levels of all the atoms in question placed on the line of sight of the apparatus or observer. Therefore, the measured intensity is not only the sum of all the emissions of the plasma, because it is necessary to take into account this self-absorption.

The self-absorption effect, which is well known in spectroscopy of plasmas for elementary analysis, is rather considered to be an undesirable effect because it leads to a distortion of the profile of the line, and therefore to a nonlinearity in the signal with respect to the concentration of the element of interest. Reference may for example be made to patent FR2938066, which relates to the measurement of the elementary composition of an element.

It is therefore generally sought to remove or at the very least minimise or even avoid this effect, as it is desired to minimise or avoid the Stark effect (see the introduction of the present patent application), in order to improve the resolving power of the measuring system, and not to use it as a signal to be exploited.

The inventors have on the contrary thought to exploit the self-absorption effect in order to deduce therefrom information on the isotopes of a given element in a material.

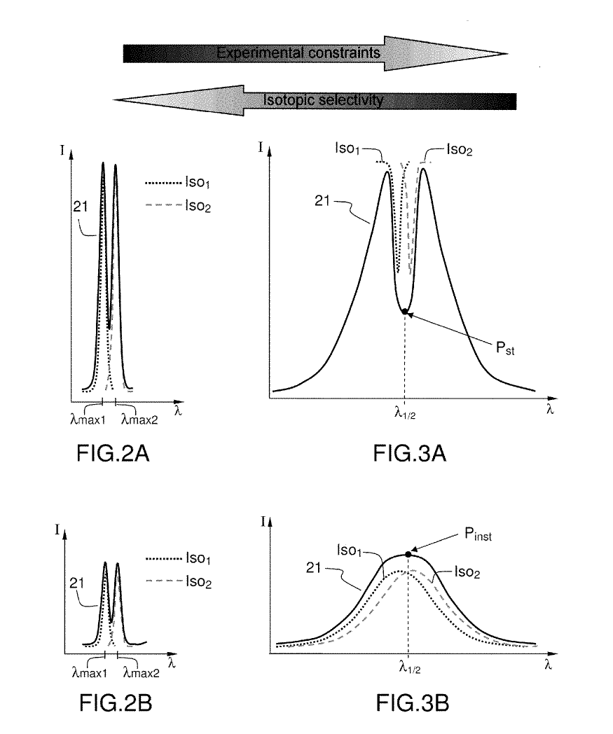

FIGS. 2A and 2B show a line 21 of an element of interest. They show the line 21 obtained in two particular cases, depending on the concentration of the element in the material.

The line 21 was selected from a spectrum 20 obtained using a prior-art LIBS method in which the analysis was carried out at low pressure or even under vacuum. By thus limiting the confinement of the plasma by the ambient medium, its density is decreased, thus minimising broadening of the lines by the Stark effect, and it is therefore possible to achieve a sufficient spectral selectivity between two isotopes Iso₁ and Iso₂. Specifically, a double line is obtained and may be seen:
The intensity Iₘₐₓ₁ of one line allows the wavelength λₘₐₓ₁ that corresponds to isotope 1 (Iso₁) to be determined.
The intensity Iₘₐₓ₂ of other line allows the wavelength λₘₐₓ₂ that corresponds to isotope 2 (Iso₂) to be determined.
The isotope ratio Iso₁/Iso₂ may be deduced therefrom by taking the ratio Iₘₐₓ₁/Iₘₐₓ₂.

However this method is possible only for some isotopes. Furthermore, it is at the detriment of ease of experimental implementation, because of the need to work at low pressure or even under vacuum, and with a spectrometer of high resolving power.

FIGS. 3A and 3B show a line 21 of an element of interest. The line 21 was selected from a spectrum 20 obtained using a method according to the invention that does not require a low pressure to be applied. The figures show the line 21 obtained in two particular cases, depending on the concentration of the element in the material.

FIG. 3A illustrates the case in which the element is in high concentration in the plasma; the self-absorption effect is then marked. A line profile that is hollow at its centre, resulting from the superposition of a spectrally broad emission profile and a spectrally narrower absorption profile, is observed.

In this case the value of the optimal wavelength λ_{1,2} corresponding to the absorption hollow is measured. Said optimal wavelength is in this case measured on the segment of the profile corresponding to the absorption (namely to λ_{1,2 abs}), i.e. to the minimum point of the observed hollow (point Pₛₜ of stable equilibrium). It is correlated to the ratio between two isotopes Iso₁ and Iso₂ of the element in question, and it is shifted depending on said isotope ratio.

FIG. 3B illustrates the case in which the concentration of the element in the plasma is lower; the self-absorption effect is then less marked or even absent. A spectrally broad line profile that does not have a hollow at its centre is obtained.

In this case the value of the optimal wavelength λ_{1,2} corresponding to the emission peak is measured. Said optimal wavelength is in this case measured on the segment of the profile corresponding to the emission (namely to λ_{1,2 em}), i.e. to the maximum point of the observed curve (point Pᵢₙₛₜ of unstable equilibrium). It is correlated to the ratio between two isotopes Iso₁ and Iso₂ of the element in question, and it is shifted depending on said isotope ratio.

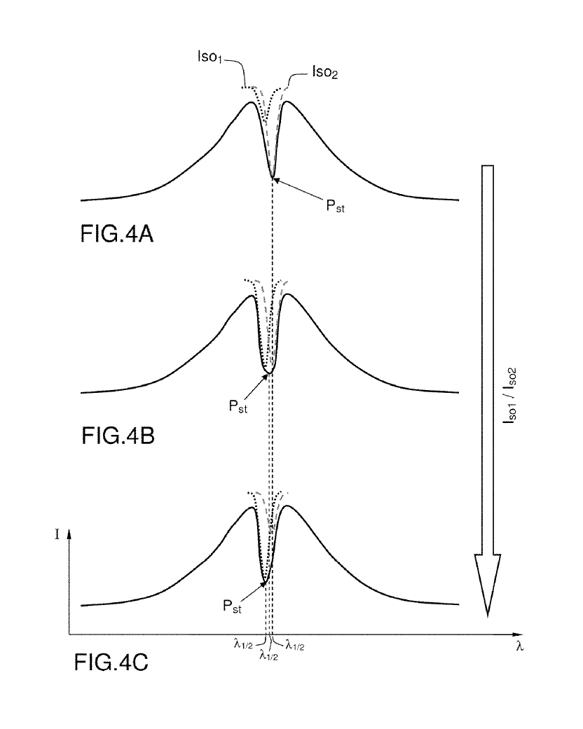

FIGS. 4A, 4B and 4C illustrate a line 21 selected from the spectrum obtained at atmospheric pressure as a function of various isotope ratios. Isotopes Iso₁ and Iso₂ are shown in these figures and the latter illustrate a case in which the concentration of the element in the plasma is high, and in which a line profile that is hollow at its centre is observed. The value of the optimal wavelength λ_{1,2} corresponding to the absorption hollow (point Pₛₜ of stable equilibrium) is measured. The optimal wavelength is in this case measured on the segment of the profile corresponding to the absorption (λ_{1,2 abs}).

It may be seen that said optimal wavelength λ_{1,2} is correlated to the ratio between two isotopes Iso₁ and Iso₂ of the element in question, and that it is shifted depending on said isotope ratio.

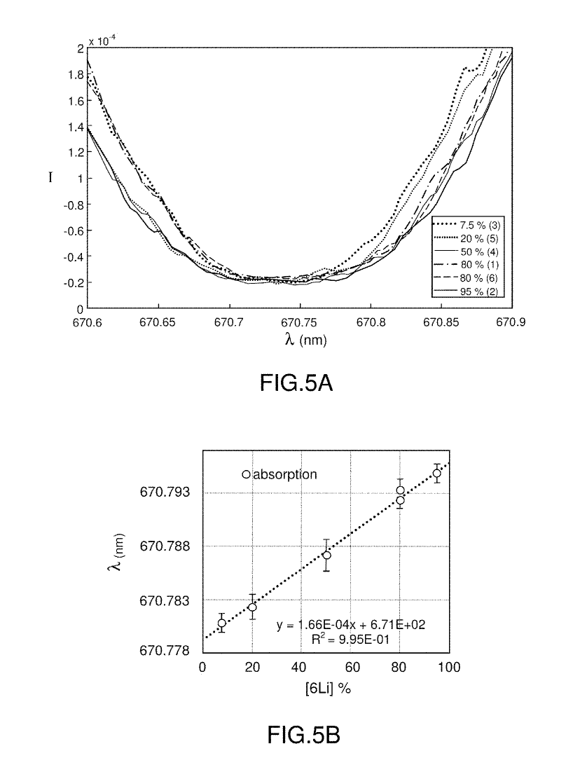

FIG. 5A gives a few experimental results that show various determined line profiles taken from various spectra obtained from lithium-carbonate samples of variable ⁷Li/⁶Li isotope ratio. The experimental results are corrected for the electronic background of the camera and normalised with respect to the integrated area of the spectrum. The percentages indicate the relative ⁶Li content (the complement being the ⁷Li content) and the numbers between parentheses indicate the order of passage of the samples.

The measurements were carried out on a plurality of lithium-carbonate (Li₂CO₃) samples of variable ⁷Li/⁶Li isotope ratios. Iso₁ is ⁷Li and Iso₂ is ⁶Li.

For this element, the natural isotopic abundance is 7.5% for ⁶Li and 93.5% for ⁷Li. The samples were prepared in the form of pastilles from variable mixtures of two commercial powders, one of natural Li₂CO₃ and the other of Li₂CO₃ enriched to 95% with ⁶Li (Sigma-Aldrich). The various fractions of ⁶Li in the pastilles were set to 7.5%, 20%, 50%, 80% and 95%, i.e. ⁷Li/⁶Li isotope ratios of 12.3, 4, 1, 0.25 and 0.053, respectively. The order in which the samples were measured was randomly chosen.

A plurality of laser shots were carried out on each sample, so as to generate a plasma. Thus, for each example, 25 spectra were recorded, each thereof resulting from 20 accumulated laser shots at the same point of said sample.

It is preferable to carry out a plurality of laser shots in order to improve the signal-to-noise ratio. This is especially advantageous when it is desired to establish a shift between two isotopes that is very small, as indicated above. With a 20 Hz laser, one second is enough to perform 20 shots. This does not increase the duration of the isotopic measuring method.

The delay between the step of applying the laser beam and the step of measuring by spectrometry, in other words the delay between a laser shot and the measurement, was 1.75 μs for each laser shot.

The exposure time of the spectrometer (of its detector) on each laser shot (or time window of integration of the signal) was 0.500 μs.

Between each sample, a lithium hollow-cathode lamp was measured in order to verify the absence of temperature drift from the spectrometer.

The spectra were recorded with a commercial LIBS system (Mobilibs, Ivea) associated with a spectrometer of 1 m focal length (THR1000, Jobin-Yvon) equipped with an intensified camera (iStar, Andor) centred on 670.755 nm, the wavelength of the most intense line of ⁷Li. The laser had a wavelength of 266 nm and the pulse energy was adjusted to 5.1 mJ.

Two main spectral lines are known for lithium and were identified in the various obtained spectra:
for ⁷Li, the maximal wavelength λₘₐₓ of the first line is 670.775 nm and the maximal wavelength λₘₐₓ of the second line is 670.790 nm;
for ⁶Li, each line is shifted toward the red by about 17 pm. Therefore two lines at 670.792 nm and 670.807 nm are obtained.

FIG. 5A shows the obtained spectra, and in particular the various line profiles obtained for the various mixtures of ⁷Li and ⁶Li. The hollow of the hollowed-in-the-middle double-bell shape of the line is clearly visible: it corresponds to the self-absorption profile. In this case, the point of stable equilibrium, corresponding to the lowest point of the hollow, is determined and the value of the optimal wavelength λ_{1,2} corresponding to the hollow of the self-absorption profile is measured.

The optimal wavelength λ_{1,2} was determined experimentally by fitting the absorption hollow with a Lorentzian profile.

FIG. 5B shows an obtained curve, giving the optimal absorption wavelength as a function of the concentration in ⁶Li of the sample. The error bars represent ±2σ over the average of the 25 repeats (i.e. ±2σ₀/√25 with σ₀ the standard deviation over the 25 repeats).

A very good linearity is observed, showing that it is therefore possible to quantify the isotope ratio with this method, and without calibrating the signal with respect to intensity. It is enough to measure the optimal wavelength λ_{1,2}.

In the presented example, the optimal wavelength λ_{1,2} is measured on the segment of the profile corresponding to the absorption (λ_{1,2 abs}).

The resolving power λ/Δλ of the spectrometer used was determined to be 37200 using the hollow-cathode lamp (λ=670 nm and full width at half maximum Δλ=18 pm). This resolution was enough to determine the isotope ratio between the two isotopes ⁷Li and ⁶Li.

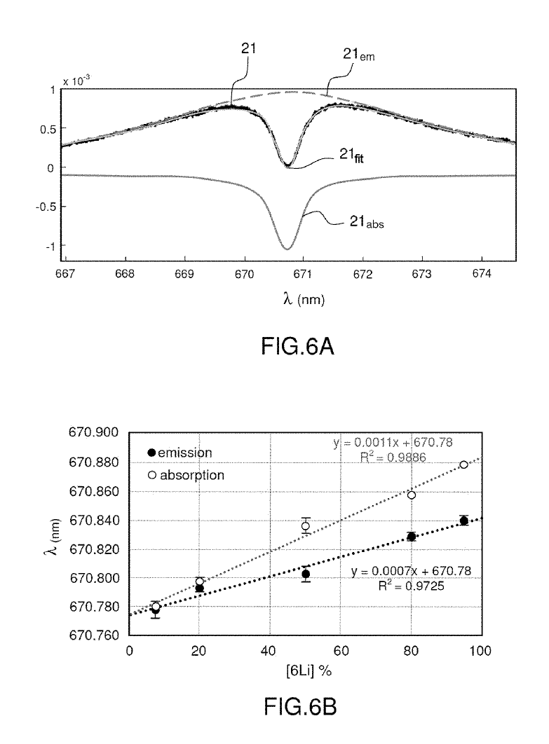

FIGS. 6A and 6B show another embodiment of the method.

Instead of considering a measured spectral line that is the sum of an absorption line and of an emission line, the present embodiment consists in taking into account each of the absorption and emission lines (in other words each of the absorption and emission contributions of the measured spectral line).

Thus, if FIG. 6A is referred to, the curve 21 corresponds to a measured spectral line of interest. An absorption curve 21_{abs} that corresponds to a fit to the absorption component of the curve 21 is shown. Furthermore, a virtual emission curve 21ₑₘ that corresponds to a fit to the emission component of the curve 21 is constructed.

The fitted curve 21_{fit} corresponds to a final fit that is the sum of the two curves, i.e. of the absorption curve 21_{abs} and emission curve 21ₑₘ. It must correspond, to within measurement and/or fitting errors, to the measured curve 21.

The wavelength of the absorption contribution (point of stable equilibrium) shifts with the isotope ratio.

Furthermore, the wavelength of the emission contribution (admittedly virtual point of unstable equilibrium) also shifts with the isotope ratio.

Either one (or both) of these absorption and emission curves may be therefore used to determine the isotope ratio of an element of interest.

FIG. 6B illustrates the results of this embodiment for ⁶Li and gives the optimal absorption wavelength as a function of the concentration in ⁶Li with respect to ⁷Li of the sample

A good linearity is again observed, showing that it is therefore possible to quantify the isotope ratio with this embodiment. It is enough to measure the optimal wavelength λ_{1,2}, and said wavelength may be measured either on an absorption profile or on an emission profile.

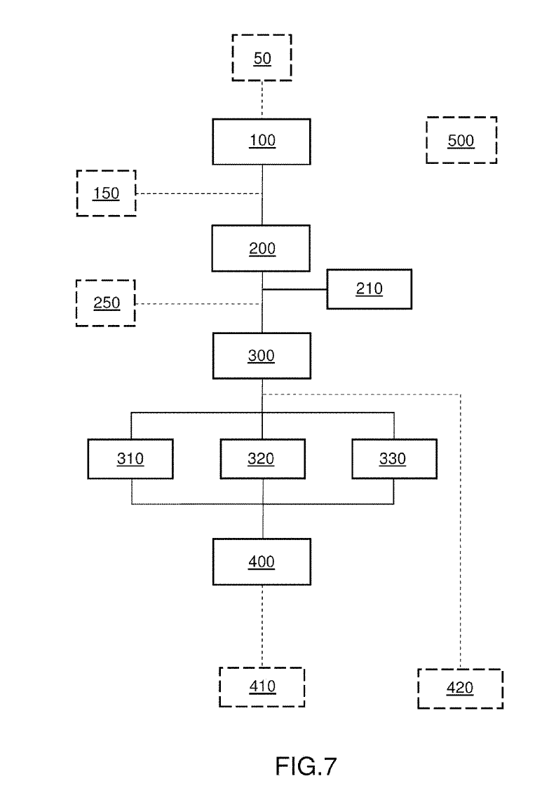

FIG. 7 illustrates the steps of the method according to the invention. The measuring method comprises the following steps:
a step 100 of applying at least one laser beam to the material to be analysed so as to generate a plasma, said plasma being able to emit a light spectrum comprising a plurality of spectral lines emitted by the elements of the material;
a measuring step 200 carried out consecutively to the applying step 100 and able to measure the profile of at least one spectral line of interest emitted by the element of interest, said measuring step comprising carrying out, with a spectrometer, at least one step 210 of analysing the light spectrum emitted by the plasma;
a processing step 300 carried out consecutively to the measuring step 200 and able to note from the measured profile of the spectral line of interest, the optimal wavelength corresponding to a point of equilibrium of said profile. It may be a question:
   either of the point of stable equilibrium of said profile when the profile of the spectral line has a double-bell shape (substep 310);
   or of the point of unstable equilibrium of said profile when the profile of the spectral line has a bell shape (substep 320); and
a determining step 400 carried out consecutively to the processing step 300 and able to determine the isotope ratio depending on the noted optimal wavelength.

Furthermore, the measuring method may comprise a step 50 of emitting a laser beam with emitting means, such as a laser generator, prior to the applying step 100. The emission of said laser beam is preferably carried out in pulses.

The method may comprise a preselecting step 150 prior to the measuring step 200 and able to preselect at least one spectral line profile corresponding to the element of interest.

The method may comprise a post-selecting step 250 carried out after the measuring step 200 and able to select a spectral line of interest corresponding to the element of interest from a plurality of measured spectral lines.

The method may comprise a step 500 of generating a correlation function between an isotope ratio and an optimal wavelength, for a given element. This step may preferably be carried out before the applying step 100.

In this case, the step 400 of determining the isotope ratio may comprise a step 410 of comparing the noted optimal wavelength with said correlation function.

Alternatively, the step 400 of determining the isotope ratio may comprise a step 420 of implementing a multivariate method, for example the partial-least-squares or neural-network regression method. In this case, the processing step 300 and the step 400 of determining the isotope ratio may be merged into one, as indicated in FIG. 7.

The method according to the invention allows a ratio between two isotopes of an element to be measured.

To implement the method according to the invention, a known LIBS device such as illustrated in FIG. 1A may be used at atmospheric pressure.

It may be even simpler because it is enough to provide a single laser generator able to generate at least one laser beam, one optical system, for example a lens, and one spectrometer.

The laser generator will preferably deliver pulsed laser beams.

It is therefore one advantage of the method according to the invention to be able to use an LIBS device, the advantages of which are known:
it is rapid, a spectrum being obtained in a few microseconds by laser shot;
the sample or the material may be solid, liquid or gaseous;
it is not necessary to prepare the sample;
it may be compact: there are lasers and spectrometers that are sufficiently small to allow a portable and stand-alone LIBS device to be provided;
it is possible to carry out measurements at a distance of up to several tens of meters by adjusting the focusing optic of the laser; and
its cost is relatively low, above all compared to that of standard mass-spectrometry-based isotopic measuring instruments such as ICP-MS instruments.

Thus, the method according to the invention may be implemented in the field, without particular preparation of a sample. It is therefore not necessary in certain cases to move the material, this possibly being an enormous advantage when the materials are radioactive and/or contaminants (time-saving, minimisation of risks, etc.).

Another advantage of the method according to the invention is to allow rapid isotopic analysis on a production line, for example for the inspection of industrial production of nuclear material.

The material may take the form of a solid, liquid, gas, or even the form of an aerosol.

The method according to the invention allows the use of spectrometers of high resolving power to be avoided.

The present invention is not limited to the embodiments or examples described above but encompasses any embodiment falling within the scope of the claims.

The present invention may apply to:
the inspection of nuclear sites (by personnel of the IAEA for example) with a view to combating nuclear proliferation or providing guarantees;
isotopic analysis on a production line in a plant for producing or enriching nuclear material;
the characterisation of fuel debris after an accident;
nuclear legal medicine; and/or
other non-nuclear fields of application: archaeology, geology, palaeoclimatology, national security, etc.

1. A method for measuring an isotope ratio of an element of interest present in a material including a plurality of elements, said measuring method comprising the following steps:
a step of applying at least one laser beam to the material so as to generate a plasma, said plasma being able to emit a light spectrum comprising a plurality of spectral lines emitted by the elements of the material; and
a measuring step carried out consecutively to the applying step and able to measure the profile of at least one spectral line of interest emitted by the element of interest, said measuring step comprising carrying out, with a spectrometer, at least one analysis of the light spectrum emitted by the plasma;
wherein the method furthermore comprises:
a processing step carried out consecutively to the measuring step and able to establish, depending on the measured profile of the spectral line of interest, the optimal wavelength (λ_{1,2}) corresponding either to the point (Pₛₜ) of stable equilibrium corresponding to the hollow between two bells when the profile has a double-bell self-absorption profile, or to the point (Pᵢₙₛₜ) of unstable equilibrium corresponding to the apex of the bell profile when the profile is a single bell; and
a determining step carried out consecutively to the processing step and able to determine the isotope ratio (Iso₁/Iso₂) depending on the noted optimal wavelength (λ_{1,2}), said determining step comprising either a step of comparing with a correlation function between an isotope ratio (Iso₁/Iso₂) and an optimal wavelength (λ_{1,2}) for a given element, or a step of implementing a multivariate method.

2. The measuring method according to claim 1, the measuring method comprising a step of emitting a laser beam with emitting means, such as a laser generator, prior to the applying step, the emission of said laser beam being carried out in pulses.

3. The measuring method according to claim 1, the measuring step being able to measure the profiles of all or some of the plurality of spectral lines of the light spectrum emitted by the plasma.

4. The measuring method according to claim 1, comprising a preselecting step prior to the measuring step and able to preselect at least one spectral line profile corresponding to the element of interest.

5. The measuring method according to claim 4, the preselecting step being carried out by selecting at least one measurement spectral band corresponding to the element of interest.

6. The measuring method according to claim 4, the preselecting step being carried out using a database of correspondences between spectral lines and elements.

7. The measuring method according to claim 4, the measuring step comprising a step of centring the spectrometer on the at least one preselected spectral line profile, for example in the at least one preselected measurement spectral band.

8. The measuring method according to claim 1, comprising a post-selecting step carried out after the measuring step and able to select a spectral line of interest corresponding to the element of interest from a plurality of measured spectral lines.

9. The measuring method according to claim 8, the post-selecting step being carried out using a database of correspondences between spectral lines and elements.

10. The measuring method according to claim 8, the post-selecting step being carried out by viewing the profiles of the measured spectral lines and selecting, for the element of interest, a profile of a spectral line of interest.

11. The measuring method according to claim 1, the profile of the spectral line of interest having a double-bell shape with an absorption hollow between the two bells, the processing step comprising a step of establishing the point (Pₛₜ) of stable equilibrium of said profile corresponding to the lowest point of the hollow.

12. The measuring method according to claim 1, the profile of the spectral line of interest having a bell shape, the processing step comprising a step of establishing the point (Pᵢₙₛₜ) of unstable equilibrium of said profile corresponding to the apex of the bell.

13. The measuring method according to claim 1, a measurement delay being respected between the step of applying a laser beam and the measuring step.

14. The measuring method according to claim 1, the measuring step comprising applying an exposure time of the spectrometer to each laser beam.

15. The measuring method according to claim 1, the processing step being carried out by analysing the profile of the spectral line of interest.

16. The measuring method according to claim 1, comprising a step of generating a correlation function between an isotope ratio (Iso₁/Iso₂) and an optimal wavelength (λ_{1,2}), for a given element, the step of determining the isotope ratio (Iso₁/Iso₂) comprising a step of comparing the noted optimal wavelength with said correlation function.

17. The measuring method according to claim 1, the processing step and the step of determining the isotope ratio being merged into one and comprising a step of implementing a multivariate method, for example the partial-least-squares or neural-network regression method.
